(19) United States
(12) Patent Application Publication
(10) Pub. No.: US 2023/0249661 A1
(43) Pub. Date: Aug. 10, 2023

(54) SPRING BRAKE ACTUATOR COMPRISING A RAM ASSEMBLY WITH A CHECK VALVE

(71) Applicant: ZF Commercial Vehicle Control Systems India Limited, Chennai (IN)

(72) Inventors: Senthil Kumar Arangarasan, Chennai (IN); Viswanathan Mahalingam, Tamil Nadu (IN); Arun Kumar Mani, Tamilnadu (IN); Suresh Sowmiyan, Chennai (IN); Aravindda Swamy Venkatesh, Chennai (IN)

(21) Appl. No.: 18/162,035

(22) Filed: Jan. 31, 2023

(30) Foreign Application Priority Data
Feb. 4, 2022 (IN) 202241005992

(51) Int. Cl. B60T 17/08; B60T 13/38; F16K 15/14

(52) U.S. Cl. CPC B60T 17/083; B60T 13/38; F16K 15/147

(57) ABSTRACT

A spring brake actuator (1) provides a service brake function and a parking brake function and comprises a housing (2) with a housing base (4). A compression spring (14) and a ram assembly (10, 11, 28) with a spring brake piston (28) are provided are provided in the housing (4). The ram assembly separates a spring chamber (12), in which the compression spring (14) is disposed, from a parking chamber (16). The spring brake actuator (1) includes a check valve (50), which is included in the ram assembly to allow an air flow to the parking chamber (16) in case of a compounding condition. The check valve (50) includes a one-way valve, for example a duckbill valve, and a supporting element for securing the one-way valve in the ram assembly.

### FIELD

The present disclosure relates to a spring brake actuator providing a service brake function and a parking brake function, the spring brake actuator including a ram assembly with a check valve.

### BACKGROUND

A spring brake actuator providing a service brake function and a parking brake function, including a ram assembly with a check valve, is widely used in compressed air brake systems of large vehicles, for example of commercial vehicles like heavy trucks, buses, and trailers. The spring brake actuator is operated using compressed air provided by a compressed-air supply container, which is filled by a compressor. The spring brake actuator comprises one or more pressure chambers and at least one diaphragm, which moves a push rod to operate a disc brake or a drum brake of the vehicle when the pressure chamber is filled with compressed air during a braking action being initiated by a respective driver of a vehicle.

The spring brake actuator typically contains a compression spring providing a force for actuating the parking brake function. The compression spring force acts on a parking piston, or a second diaphragm, via which the push rod is actuated. The compression spring can be compressed by a force appearing on the parking piston by applying compressed air in a parking chamber, which is the normal driving state of the vehicle. When the compressed air is released from the parking chamber, the compression spring expands and shifts the parking piston, which results in the activation of the parking brake and locking of the vehicle. The service brake function can be operated independently in the normal driving state, by applying compressed air in a service chamber of the spring brake actuator.

Double function brake actuators of this kind combining a service brake function with a parking brake function are known, for example, as TRISTOP™ brake actuators.

WO 2012/164587 A2 discloses a spring brake actuator providing a service brake function and a spring brake function, including a ram assembly with a check valve, and including a housing and a housing base. The check valve is, for example, an umbrella type check valve and allows a breathing function between a service chamber and a spring chamber.

### SUMMARY

It is an object of the present disclosure to provide a spring brake actuator having a lower manufacturing cost and/or an easier manufacturing.

The invention is as set out in accordance with the present disclosure and as set forth in the claims. A variety of preferred embodiments are disclosed throughout the specification.

In one aspect, a spring brake actuator provides a service brake function and a parking brake function and includes a housing with a housing base, wherein in the housing a compression spring and a ram assembly with a spring brake piston are provided. The ram assembly separates a spring chamber, in which the compression spring is disposed, from a parking chamber. The compression spring is enabled to act on the ram assembly to provide the parking brake function, in which case the spring brake piston is shifted through a hole of the housing base in the direction of a diaphragm, which causes a braking action via a push rod. The spring brake actuator further includes a check valve, which is included in the ram assembly to allow an air flow to the parking chamber, and the check valve includes a one-way valve and a supporting element for securing the one-way valve in the ram assembly. For example, the one-way valve may be a duckbill valve.

In one embodiment according to an aspect of the disclosure, the supporting element includes a ring element with an opening at one side and a tapered part at its opposing side, wherein the tapered part includes a central venting hole, which is connected at a tip of the tapered part to one or a plurality of side holes, to allow an air flow through the supporting element.

In another embodiment according to an aspect of the disclosure, the supporting element includes a ring element with an opening at one side and a tapered part at its opposing side, wherein the tapered part includes at least one hole extending in the same axial direction, offset from a central axis of the supporting element, which extends through the tapered part to allow an air flow through the supporting element.

The supporting element advantageously fixes the one-way valve in a hole of the ram assembly and provides a reinforcement and a retainment of the one-way valve to improve a backflow resistance of the one-way valve.

In another embodiment according to an aspect of the disclosure, the one-way valve is a duckbill valve and the tapered part of the supporting element has a profile, in particular a cone or a wedge profile, corresponding to a shape of elastomeric lips of the duckbill valve.

In another embodiment according to an aspect of the disclosure, the one-way valve is a metal bonded duckbill valve, and the supporting element has a form of a ring element and fixes the duckbill valve in a hole of the ram assembly. The metal bonded duckbill valve provides a high backflow resistance. Therefore, a further reinforcement of the supporting element is not provided for the metal bonded duckbill valve.

The supporting element is advantageously fitted into the ram assembly by way of a press fitting, a snap fit, a threaded fastening, an adhesive bonding, a shrink fitting, or a riveting.

In another embodiment according to an aspect of the disclosure, the ram assembly and the compression spring are located within a first space defined by the housing base and a first housing cover.

In another embodiment according to an aspect of the disclosure, the spring brake actuator includes a second housing cover, a service chamber, and a service brake spring, wherein the diaphragm is located within a second space defined by the housing base and the second housing cover, the diaphragm disposed between the service chamber and the service brake spring.

In another embodiment according to an aspect of the disclosure, the ram assembly includes a further diaphragm and a support piston, wherein the support piston includes a valve seat, in which the one-way valve is fixed by the supporting element.

The spring brake actuator is, in one aspect, a double diaphragm brake actuator or a spring brake actuator, including a parking piston with a valve seat, in which the one-way valve is fixed by the supporting element.

In another embodiment according to an aspect of the present disclosure, the spring brake actuator includes a second housing cover, wherein the diaphragm is located within a space defined by the housing base and the second housing cover, the diaphragm disposed between a service chamber and a service brake spring of the spring brake actuator.

In another embodiment according to an aspect of the disclosure, the housing base separates a parking brake part from a service brake part.

In another embodiment according to an aspect of the disclosure, the spring brake actuator is a double function brake actuators combining a service brake function with a parking brake function, also known as TRISTOP™ brake actuators.

In another embodiment according to an aspect of the disclosure, the spring brake actuator is a component of a compressed air brake system of a vehicle.

One advantage of a duckbill valve over other types of one-way valves is that the duckbill valve is self-contained, i.e., the critical sealing function is an integral part of the one-piece elastomeric component, as opposed to other valves where a sealing element has to engage with a smooth seat surface to form a seal. The duckbill valve can be easily incorporated and assembled in a hole of a support piston or a parking piston of the ram assembly without any problems associated with a surface finish quality of a mating seat and does not require a complex assembly process.

The check valve may be constructed with only two parts, a duckbill valve and a supporting element, and allows an easier assembly in the ram assembly of the spring brake actuator with regard to a prior solutions. The check valve of the present disclosure further provides a more robust design, as compared with prior solutions. A further advantage of the check valve of the present disclosure is that the threshold opening pressure of the duckbill valve is lower than the threshold opening pressure of an umbrella-type valve element.

In one embodiment according to an aspect of the disclosure, a commercial vehicle, such as a utility vehicle, includes a spring brake actuator according to the present disclosure.

### BRIEF DESCRIPTION OF THE DRAWINGS

Preferred embodiments of the present disclosure are explained in more detail below by way of example and with reference to the drawings, wherein:

FIG. 1a is a cross-sectional view of a spring brake actuator including a check valve including a one-way valve;

FIG. 1b is a front view of the spring brake actuator including the check valve including the one-way valve;

FIG. 2a is a perspective view of a duckbill valve;

FIG. 2b is an end view of the duckbill valve;

FIG. 2c is a cross-sectional view of the duckbill valve taken along line L-L of FIG. 2b;

FIG. 2d is a cross-sectional view of the duckbill valve taken along line K-K of FIG. 2b;

FIG. 2e is a schematic view of the duckbill valve in operation and in a positon to block airflow;

FIG. 2f is a schematic view of the duckbill valve in operation and in an open position allowing airflow;

FIG. 3 a perspective view of a first embodiment of the check valve;

FIG. 4 a perspective view of a second embodiment of the check valve;

FIG. 5 is a perspective view of a third embodiment of the check valve;

FIG. 6a illustrates operation of the check valve of FIG. 3;

FIG. 6b illustrates operation of the check valve of FIG. 3;

FIG. 6c illustrates operation of the check valve of FIG. 3;

FIG. 6d illustrates operation of the check valve of FIG. 3;

FIG. 7 is a perspective view of a support element with a check valve according to a prior solution;

FIG. 8a illustrates operation of the check valve of FIG. 7; and

FIG. 8b illustrates operation of the check valve of FIG. 7.

### DETAILED DESCRIPTION

With reference to the figures, the detailed description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for instructional purposes to aid the reader in understanding the principles of the disclosure and the concepts contributed by the inventors to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof.

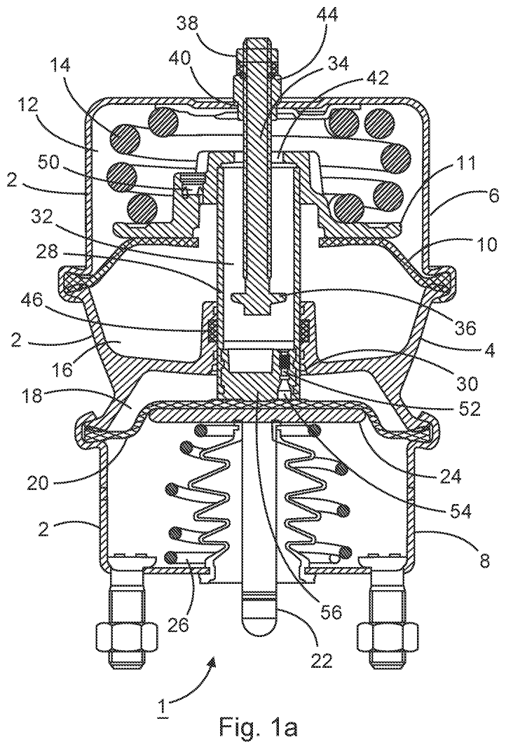

In FIG. 1a a spring brake actuator 1 is schematically depicted in a cross-sectional view, including a housing 2 with a housing base 4, a first cylindrical housing cover 6, and a second cylindrical housing cover 8. Within a first space defined by the housing base 4 and the first housing cover 6, a ram assembly with a first diaphragm 10 and a support piston 11 is provided. The first diaphragm 10 separates a spring chamber 12, in which a compression spring 14 is located, from a parking chamber 16. The compression spring 14 acts on the first diaphragm 10 via the support piston 11 and biases the first diaphragm 10 in the direction of (toward) the housing base 4. When the parking chamber 16 is filled with compressed air, the first diaphragm 10 is moved in the direction of (toward) the compression spring 14, overcoming the bias and compressing the compression spring 14. When the compressed air is released from the parking chamber 16, the compression spring 10 shifts the first diaphragm 10 in the direction of (toward) the parking chamber 16.

Within a second spaced defined by the housing base 4 and the second housing cover 8, a second diaphragm 20 is provided, which is located between a service chamber 18 and a service brake spring 26. The second diaphragm 20 is enabled to shift a push rod 22 via a push rod plate 24 for providing a braking action. The push rod 22 is coupled, for example, with a disc brake, not shown in FIG. 1a, and in the case when the service chamber 18 is filled with compressed air, the second diaphragm 20 moves the push rod 22 via the push rod plate 24, which actuates the disc brake and also compresses the service brake spring 26. When the compressed air is released from the service chamber 18, the service brake spring 26 pushes the second diaphragm 20 back, which releases the disc brake.

The compression spring 14 is, in this embodiment, a compressible cylindrical power spring and rests with one side at the first housing cover 6 and with its other side at the support piston 11. The ram assembly further includes a spring brake piston 28 connected with the support piston 11, and when the compression spring 14 shifts the first diaphragm 10 via the support piston 11, the spring brake piston 28 is moved by the support piston 11 through a hole 30 of the housing base 4 in the direction of (toward) the second diaphragm 20, which results in a movement of the second diaphragm 20 and the push rod plate 24 in the direction of (toward) the service brake spring 26, providing a braking action via the push rod 22.

The spring brake piston 28 is hollow like a tube, having a cavity 32. The spring brake actuator 1 further includes a mechanical release mechanism with an integrated release bolt 34 having a bolt head 36 and a static nut 38. The release bolt 34 extends from the outside of the spring brake actuator 1 through a hole 40 of the first housing cover 6 and a hole 42 of the support piston 11 into the cavity 32 of the spring brake piston 28. The bolt head 36 is mounted at a first end of the release bolt 34, inside the cavity 32 of the spring brake piston 28. The release bolt 34 is screwed with a thread into a boss 44, which is fixed within the hole 40 of the first housing cover 6. The boss 44 comprises a hollow inner cylindrical portion with an internal thread, which carries the release bolt 34 via the thread of the release bolt 34. The static nut 38 is screwed on the release bolt 34 at an outside end of the release bolt 34 and is fixedly attached to the release bolt 34.

The spring brake actuator 1 is usable in particular for a large vehicle, for example for a commercial vehicle. The spring brake actuator 1 provides a service brake function and a spring brake function and operates as follows. When the vehicle is running, the parking chamber 16 is filled with compressed air, but not the service chamber 18, so that the disc brake of the vehicle is not engaged and activated. Any braking action of the vehicle can then be selectively provided by a driver of the vehicle via a brake pedal, which, when pushed, results in filling the service chamber 18 with compressed air. In response, the second diaphragm 20 then moves the push rod plate 24 in the direction of (toward) the service brake spring 26, and the push rod plate 24 shifts the push rod 22 and activates the disc brake. The braking action ends when the driver releases the brake pedal, which results in the compressed air being released from the service chamber 18, with the resulting effect that the push rod 22, the push rod plate 24, and the second diaphragm 20 are shifted back by the service brake spring 26, which unlocks the disc brake. FIG. 1a depicts the spring brake actuator 1 in a driving position, with the brake not engaged.

When the vehicle is stopped and its engine is switched off, the driver can release the compressed air from the parking chamber 16 to lock the disc brake. The compression spring 14 then expands and as a result, it shifts the spring brake piston 28 via the support piston 11 in the direction of the second diaphragm 20, which moves the second diaphragm 20 in the direction of the service brake spring 26, causing the activation of the disc brake and locking of the vehicle. When the engine of the vehicle is switched on again, the disc brake can be unlocked by the driver by filling the parking chamber 16 with compressed air, which results in the first diaphragm 10 being pushed back until the compression spring 14 is fully compressed, which likewise allows the service brake spring 26 to push the push rod plate 24, push rod 22, and second diaphragm back. The brake is then released and the vehicle is ready for driving.

The spring brake actuator 1 further includes a valve element 52 in a hole 54 of a bottom 56 of the spring brake piston 28 to allow an air flow from the service chamber 18 to the cavity 32 of the spring brake piston 28 and further to the spring chamber 12. The valve element 52 is also known as an internal breather device or an internal breather valve (IBV). The spring brake actuator 1 also includes a seal 46, which is provided between walls of the hole 30 of the housing base 4 and the spring brake piston 28 to prevent a pressure equalization between the parking chamber 16 and the service chamber 18.

The spring brake actuator 1 also includes a check valve 50, which is included in this embodiment within the support piston 11. The check valve 50 includes a one-way valve and allows a pressure equalization from the spring chamber 12 to the parking chamber 16.

FIG. 1b shows the spring brake actuator 1 in a front view, with a schematic cutout 58 to depict the check valve 50, as disposed in the support piston 11, within the spring brake actuator 1.

The spring brake actuator 1 is a double function brake actuator including a parking brake part and a service brake part, wherein the parking brake part includes the compression spring 14, the parking chamber 16, the spring chamber 12, and the ram assembly with the first diaphragm 10, the support piston 11, and the spring brake piston 28 within the space defined by the first housing cover 6 and the housing base 4, and wherein the service brake part includes the second diaphragm 20, the service brake spring 26, and the service chamber 18 within the spaced defined by the second housing cover 8 and the housing base 4.

It may occur that the service brake function is applied when the disc brake is already locked by the parking brake function. Applying the service brake and the parking brake together is called a compounding braking. This can result in damaged components of the disc brake and possibly a failure of the disc brake.

A compounding braking occurs, for example, when a driver stops his vehicle on a hill and pushes the brake pedal of the vehicle to hold the vehicle, and in addition activates the parking brake function before he switches off the engine of the vehicle and releases the brake pedal. When activating the parking brake function, the compressed air is released from the parking chamber 16, which allows the compression spring 14 inside the spring chamber 12 to push the push rod 22 via the spring brake piston 28, which sets the disc brake of the vehicle. This happens while the pressurized service chamber 18 is already pushing the push rod 22 to set the brake. This combined force of spring brake and service brake forces is additive and would put an excessive force on the disc brake, which can lead to a failure of components of the disc brake.

To avoid any damage by a compounding braking, the check valve 50 allows an air flow from the service chamber 18 via the spring chamber 12 to the parking chamber 16, which in such a case reduces the air pressure within the service chamber 18, and therefore, reduces the force of the second diaphragm 20 on the push rod 22. This occurs, for example, in the spring brake actuator 1, when the service brake function is applied after the parking brake function is already applied.

The valve element 52 exists to avoid a slow pressure built-up in the service chamber 18 by depleting the air through the check valve 50 and in turn into the parking chamber 16 and in turn into the atmosphere through the air brake system of the vehicle. The open/close status of the valve element 52 is dependent on the rate of pressure build-up and pressure differential between the service chamber 18 and the parking chamber 16 at any given instant of time.

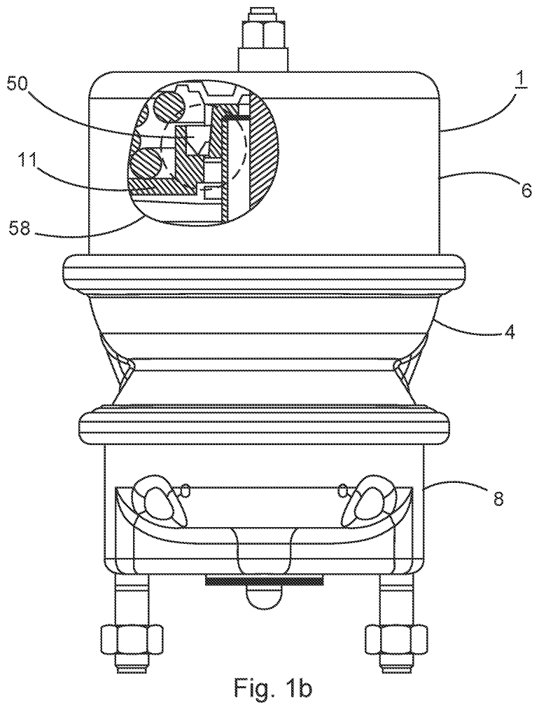

The check valve 50 includes a one-way valve. For example, the one-way valve may be a duckbill valve 60, as depicted in FIG. 2a. FIG. 2b shows the duckbill valve 60 in a top view, and FIGS. 2c and 2d in two cross-sectional views. The duckbill valve 60 is a one-piece, elastomeric component that acts as a one-way valve preventing a backflow. It has elastomeric lips 62 with a shape of duckbill lips, which allow only a forward flow from an inside 64 of the duckbill valve 60 to an outside 66 of the duckbill valve 60. One advantage of the duckbill valve 60 over other types of one-way valves is that the duckbill valve is self-contained, i.e., the critical sealing function is an integral part of the one-piece elastomeric component, as opposed to other valves where a sealing element has to engage with a smooth seat surface to form a seal. The duckbill valve 60 can be easily incorporated and assembled in the support piston 11 of the ram assembly without any problems associated with a surface finish quality of a mating seat and does not require a complex assembly process.

FIG. 2e shows the duckbill valve 60 in a situation when an air pressure is higher at a port 68 in comparison to a port 70. The elastomeric lips 62 of the duckbill valve 60 in this case prevent any air flow in the direction of an arrow 72 through the duckbill valve 60, because the air pressure is higher at the outside 66 of the duckbill valve 60 with regard to the inside 64 of the duckbill valve 60.

FIG. 2f shows the duckbill valve 60 in a situation when the air pressure is lower at the port 68 with regard to the port 70. The elastomeric lips 62 of the duckbill valve 60 open and allow in this case an air flow in the direction of arrows 74, through the duckbill valve 60, because the air pressure is higher at the inside 64 with regard to the outside 66 of the duckbill valve 60.

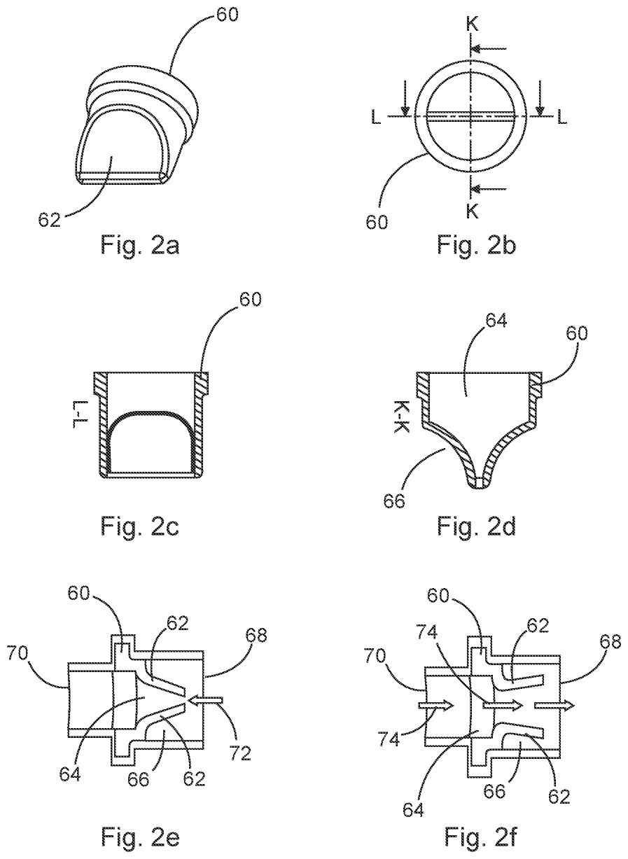

The support piston 11 is depicted, together with the check valve 50, enlarged and in an exploded view in FIG. 3. The support piston 11 includes a second hole 76 to allow an airflow from the spring chamber 12 through the support piston 11 to the parking chamber 16. The check valve 50 in this embodiment includes in addition to a duckbill valve 78 a first supporting element 80 including a ring element 82 with an opening 84 at one side and a tapered part 86 at its opposing side. The tapered part 86 includes a central venting hole 88, which is connected at a tip of the tapered part 86 to one or a plurality of side holes 90, to allow an air flow through the tapered part 86 and correspondingly through the duckbill valve 78. The ring element 82 can be designed as a separate component as well.

The duckbill valve 78 is placed in a valve seat 92 of the second hole 76, and the first supporting element 80 secures the duckbill valve 78 in the hole 76 of the support piston 11. The first supporting element 80 is fixed in the hole 76 tightly, for example using a press fitting or by screwing the first supporting element 80 into a thread of the second hole 76. Alternatively, a snap fit, an adhesive bonding, a shrink fitting, or a riveting is used for fixing the duckbill valve 78 with the first supporting element 80 in the hole 76 of the support piston 11.

With the assembly of the duckbill valve 78 and the first supporting element 80 in the support piston 11, only an air flow from the service chamber 18 via the valve element 52 and the spring chamber 12 to the parking chamber 16 is allowed. The tapered part 86 of the first supporting element 80 has in particular a cone or a wedge profile similar to the elastomeric lips 62 of the duckbill valve 78, to support the backflow resistance of the duckbill valve 78.

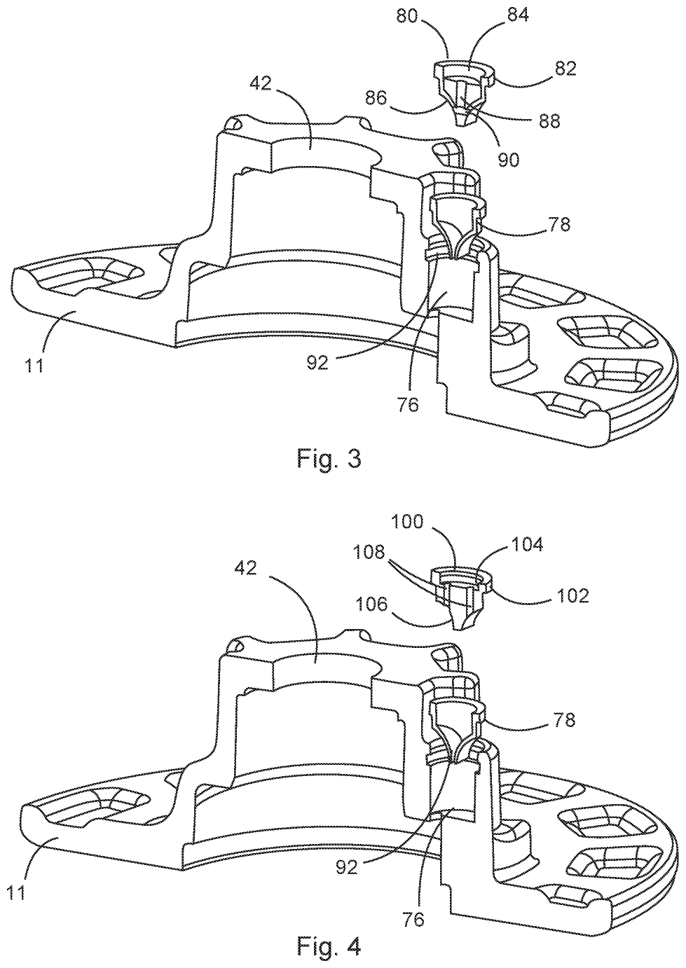

Another preferred embodiment of the check valve 50 is shown in FIG. 4. The check valve 50 in this embodiment comprises the duckbill valve 78 and a second supporting element 100, which comprises a ring element 102 at one side with an opening 104 and a tapered part 106 at its opposing side. The tapered part 106 has an outside shape equal or similar to the first supporting element 80 but includes one or a plurality of holes 108, extending in the same axial direction, which are located offset from a central axis of the second supporting element 100, and which holes 108 pass straight through the second supporting element 100 to allow an airflow through the second supporting element 100. The ring element 102 can be designed as a separate component as well.

The second supporting element 100 fixes the duckbill valve 78 tightly in the valve seat 92 of the hole 76, after the duckbill valve 78 is placed in the hole 76, and the tapered part 106 of the second supporting element 100 supports the backflow resistance of the duckbill valve 78. The second supporting element 100 is fixed in the hole 76, for example using a press fitting or by screwing the second supporting element 100 into a thread of the hole 76. Alternatively, a snap fit, an adhesive bonding, a shrink fitting, or a riveting is used for fixing the duckbill valve 78 in the hole 76 of the support piston 11.

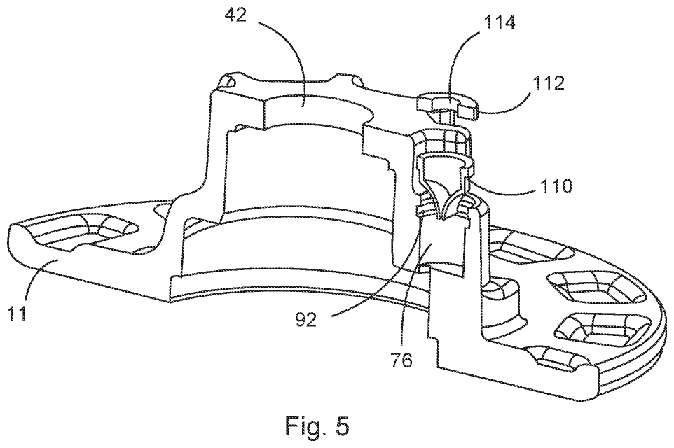

A further preferred embodiment of the check valve 50 is shown in FIG. 5. The check valve 50 in this embodiment includes a metal bonded duckbill valve 110 and a third supporting element 112 having the form of a ring element. The third supporting element 112 includes a central hole 114 and fixes the duckbill valve 110 within the valve seat 92 of the hole 76 of the support piston 11 tightly, so that only an airflow from the spring chamber 12 to the parking chamber 16 is possible. The metal within the duckbill valve 100 improves the backflow resistance of the duckbill valve 100, so that a separate stabilizing function, as provided by the first supporting element 80 or the second supporting element 100, is not used in this embodiment.

The third supporting element 112 secures the duckbill valve 110 in the valve seat 92 of the hole 76, after the duckbill valve 110 is mounted in the hole 76. The third supporting element 112 is fixed in the hole 76, for example by using a press fitting or by screwing the third supporting element 110 into a thread of the hole 76. Alternatively, a snap fit, an adhesive bonding, a shrink fitting, or a riveting is used for fixing the duckbill valve 110 in the hole 76 of the support piston 11.

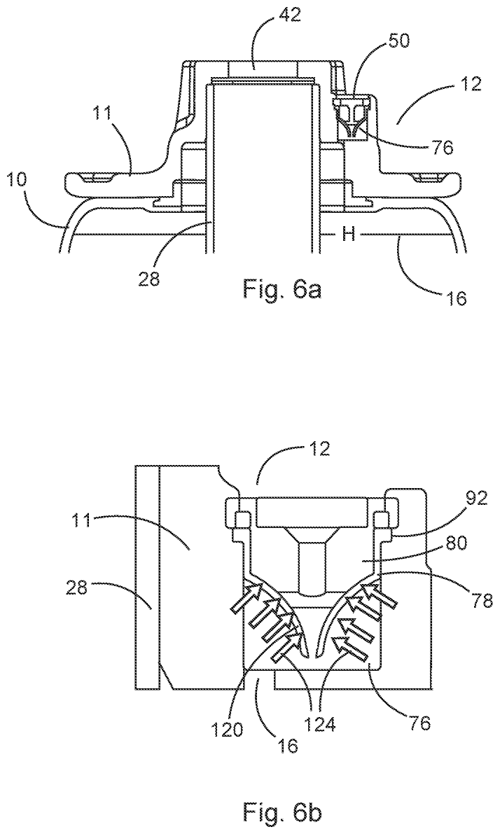

The operation of the check valve 50 is now described with reference to FIGS. 6a-6d. FIG. 6a schematically shows details of the ram assembly with the first diaphragm 10, the support piston 11, the spring brake piston 28, the check valve 50 in accordance with first embodiment as shown in FIG. 3, the spring chamber 12, and the parking chamber 16. FIG. 6b shows the check valve 50 of FIG. 6a enlarged in more detail. The duckbill valve 78 is placed in the valve seat 92 of the hole 76 and secured by the first supporting element 80.

FIGS. 6a and 6b show a situation in which the parking chamber 16 is pressurized, pressure H, because the parking brake function is not actuated. The service chamber 18 (not shown in FIG. 6a) is not pressurized. This is the case, for example, when the vehicle is driving on a road. The pressure in the spring chamber 12 (top side of FIG. 6c) is then lower than the pressure in the parking chamber 16 (bottom side of FIG. 6a). The pressure of the parking chamber 16 therefore acts on an outside 120 of the duckbill valve 78 facing the parking chamber 16, as shown in FIG. 6b, because the hole 76 (in support piston 11) is open to the parking chamber 16. The duckbill valve 78 is, therefore, closed. The pressure on the outside 120 of the duckbill valve 78, caused by the pressurized parking chamber 16, is indicated by arrows 122.

FIG. 6c again schematically shows details of the ram assembly with the first diaphragm 10, the support piston 11, and the spring brake piston 28, the check valve 50 in accordance with first embodiment as shown in FIG. 3, the spring chamber 12 and the parking chamber 16. FIG. 6d shows the check valve 50 of FIG. 6c enlarged in more detail. The duckbill valve 78 is placed in the valve seat 92 of the hole 76 and secured by the first supporting element 80.

FIGS. 6c and 6d illustrate a situation with a compounding condition, in which the service brake function is actuated together with the parking brake function. The pressure in the parking chamber 16 is then low, for example about 0 bar, but the pressure in the spring chamber 12 is high, pressure H, because the pressure in the service chamber 18 is high, in which case the valve element 54 (not shown in FIG. 6c) opens, and an air flow from the service chamber 18 via the valve element 54 and the cavity 32 of the spring brake piston 28 to the spring chamber 12 takes place. The elastomeric lips of the duckbill valve 78 therefore open in this situation, as shown I FIG. 6d, and allow an air flow from the service chamber 18 via the valve element 54 and the spring chamber 12 to the parking chamber 16. The air flow is indicated by arrows 124. The air pressure in the service chamber 18 is, therefore, reduced in this compounding situation and correspondingly, the force on the push rod 22 is also reduced.

The spring brake actuator 1 is, as described above, a double diaphragm type brake actuator. However, in another preferred embodiment, the spring brake actuator 1 includes a parking piston instead of the first diaphragm 10, wherein the parking piston separates the spring chamber 12 from the parking chamber 16. For purposes of general illustration, the support piston 11 illustrated in FIGS. 3-5 may be viewed as said parking piston, in which said diaphragm is not provided in this alternative embodiment.

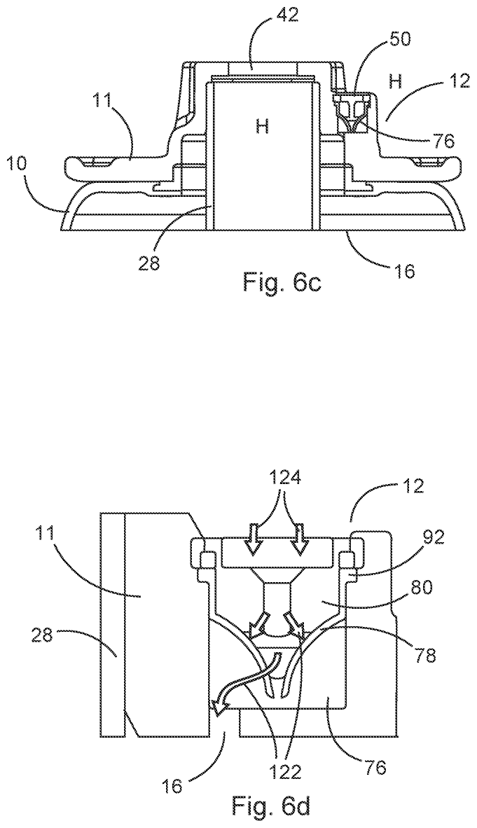

FIG. 7 depicts a support element 130 including a hole 132, in which a check valve 134 according to prior art is disposed. The check valve 134 comprises an umbrella-type valve element 136, which is fixed in the hole 132 by using a retainer plate 138 and a circlip 140. The umbrella-type valve element 136 includes a sealing elastomeric diaphragm, which is shaped as a disk or an umbrella, and which is used as a backflow prevention device.

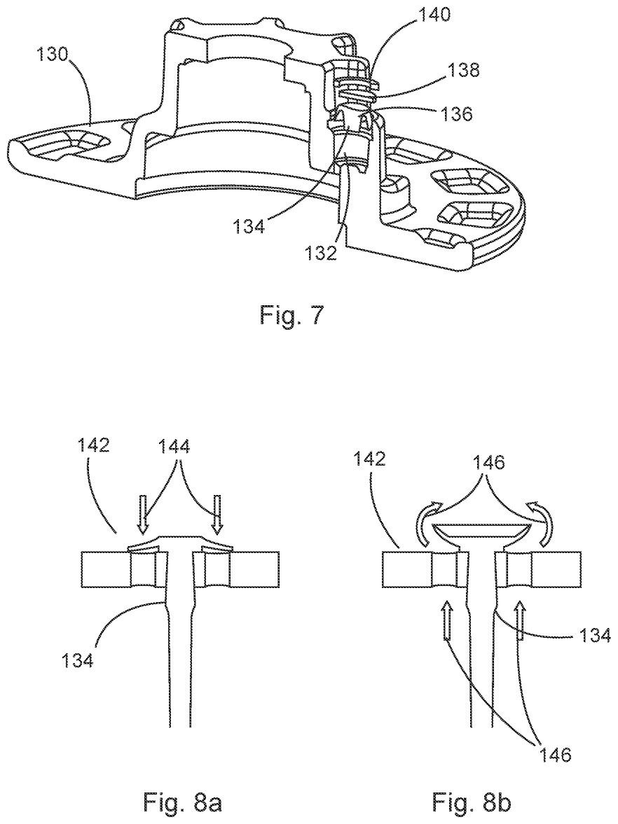

FIGS. 8a, 8b show an operation of the check valve 134 of FIG. 7. If the pressure is higher at an umbrella side 142 of the umbrella-type valve element 136, indicated by arrows 144, the check valve 134 is closed, as shown in FIG. 8a. If the pressure is lower at the umbrella side 142, the check valve 134 is open, as indicated by arrows 146 in FIG. 8b.

The check valve 50 of the present disclosure may comprise only two parts, a duckbill valve and a supporting element, and allows an easier assembly in the ram assembly of the spring brake actuator 1 relative to the prior solution. The check valve 50 of the present disclosure also provides a more robust design, as compared with the prior solution. A further advantage of the check valve 50 is that the threshold opening pressure of the duckbill valve is lower than the threshold opening pressure of the umbrella-type valve element.

Also, other embodiments may be utilized by one skilled in the art without departing from the scope of the present disclosure. The disclosure resides therefore in the claims hereinafter appended.

### LIST OF REFERENCE SIGNS (PART OF THE SPECIFICATION)

1 spring brake actuator
2 housing
4 housing base
6 first housing cover
8 second housing cover
10 first diaphragm
11 support piston
12 spring chamber
14 compression spring
16 parking chamber
18 service chamber
20 second diaphragm
22 push rod
24 push rod plate
26 service brake spring
28 spring brake piston
30 hole of the housing base
32 cavity
34 release bolt
36 bolt head
38 static nut
40 hole of the first housing cover
42 hole of the support piston
44 boss
46 seal
50 check valve
52 valve element
54 hole of the bottom 56
56 bottom
58 opening of the spring brake actuator
60 duckbill valve
62 elastomeric lips
64 inside of the duckbill valve 60
66 outside of the duckbill valve 60
68, 70 ports
72, 74 arrows
76 second hole of the support piston
78 duckbill valve
80 first supporting element
82 ring element of the first supporting element
84 opening
86 tapered part
88 central hole
90 side holes
92 valve seat
100 second supporting element
102 ring element of the second supporting element
104 opening
106 tapered part
108 holes
110 metal bonded duckbill valve
112 third supporting element
114 hole of the supporting element 112
120 outside of the duckbill valve 60
122, 124 arrows
130 support element
132 hole
134 check valve according to prior art
136 umbrella-type valve
138 retainer plate
140 circlip
142 umbrella side of the umbrella-type valve
144, 146 arrows
H high pressure

1. A spring brake actuator (1) providing a service brake function and a parking brake function, the spring brake actuator comprising:
a housing (2) with a housing base (4),
a compression spring (14) and a ram assembly (10, 11, 28) with a spring brake piston (28) disposed in the housing (2),
wherein the ram assembly (10, 11, 28) separates a spring chamber (12), in which the compression spring (14) is disposed, from a parking chamber (16),
wherein the compression spring (14) acts on the ram assembly (10, 11, 28) and provides the parking brake function, in which the spring brake piston (28) shifts through a hole (30) of the housing base (4) toward a diaphragm (20) and causing a braking action via a push rod (22),
a check valve (50) of the ram assembly (10, 11, 28) that allows an air flow to the parking chamber (16),
wherein the check valve (50) includes a one-way valve (60, 78, 110) and a supporting element (80, 100, 112) that secures the one-way valve (60, 78, 110) in the ram assembly (10, 11, 28).

2. The spring brake actuator (1) of claim 1, wherein the one-way valve is a duckbill valve (60, 78, 110).

3. The spring brake actuator (1) of claim 2, wherein the supporting element (80) comprises a ring element (82) with an opening (84) at one side and a tapered part (86) at its opposing side, and wherein the tapered part (86) includes a central venting hole (88), which is connected at a tip of the tapered part (84) to one or a plurality of side holes (90), that allows an air flow through the supporting element (80).

4. The spring brake actuator of claim 3, wherein the tapered part (86) has a cone or a wedge profile corresponding to a shape of elastomeric lips (62) of the duckbill valve (60, 78).

5. The spring brake actuator (1) of claim 2, wherein the supporting element (100) comprises a ring element (102) with an opening (104) at one side and a tapered part (106) at its opposing side, and wherein the tapered part (106) includes at least one hole (108) extending in the same axial direction, offset from a central axis of the supporting element (100), which extends axially through the tapered part (106) and allows an air flow through the supporting element (100).

6. The spring brake actuator of claim 5, wherein the tapered part (106) has a cone or a wedge profile corresponding to a shape of elastomeric lips (62) of the duckbill valve (60, 78).

7. The spring brake actuator (1) of claim 2, wherein the supporting element (80, 100) fixes the duckbill valve (60, 78) in a hole (76) of the ram assembly (10, 11, 28) and provides a reinforcement and a retainment of the duckbill valve (60, 78) and provides a backflow resistance to the duckbill valve (60, 78).

8. The spring brake actuator (1) of claim 2, wherein the supporting element (80, 100) has an outer shape corresponding to an inner shape of the duckbill valve (60, 78).

9. The spring brake actuator (1) of claim 2, wherein the one-way valve is a metal bonded duckbill valve (110), and wherein the supporting element (112) is a ring element and fixes the duckbill valve (110) in a hole of the ram assembly (10, 11, 28).

10. The spring brake actuator of claim 9, wherein the ring element has an outer shape that does not correspond to the inner shape of the metal bonded duckbill valve, thereby defining a space therebetween when assembled, wherein the metal bonded duckbill valve is self-supporting against backflow.

11. The spring brake actuator (1) of claim 1, wherein the supporting element (80, 100, 112) is fitted into the ram assembly (10, 11, 28) by way of a press fitting, a snap fit, a threaded fastening, an adhesive bonding, a shrink fitting, or a riveting.

12. The spring brake actuator (1) of claim 1, wherein the ram assembly (10, 11, 28) and the compression spring (14) are located within a first space defined by the housing base (4) and a first housing cover (6).

13. The spring brake actuator (1) of claim 12, further comprising a second housing cover (8), a service chamber (18), and a service brake spring (26), wherein the diaphragm (20) is located within a second space defined by the housing base (4) and the second housing cover (8), the diaphragm (20) disposed between the service chamber (18) and the service brake spring (26).

14. The spring brake actuator (1) of claim 13, wherein the ram assembly (10, 11, 28) includes a further diaphragm (10) and a support piston (11), and wherein the support piston (11) includes a valve seat (92), in which the one-way valve (60, 78, 110) is fixed by the supporting element (80, 100, 112).

15. The spring brake actuator (1) of claim 13, further comprising a parking piston, which separates the spring chamber (12) from the parking chamber (16), and which includes a valve seat, in which the one-way valve (60, 78, 110) is fixed by the supporting element (80, 100, 112).

16. The spring brake actuator (1) of claim 1, wherein when compound braking occurs in which the parking brake function and the service brake function are both activated, high pressure in the service chamber vents through a valve element into the spring brake piston and into the spring chamber, and the high pressure passes through the supporting element and the one-way valve from the spring chamber into the parking chamber until pressure equalization is reached between the parking chamber, and the spring chamber and the one-way valve closes and blocks backflow.

17. The spring brake actuator of claim 1, wherein the check valve is constructed of only two parts, wherein the two parts are a duckbill valve and the supporting member, wherein the duckbill valve includes elastomeric lips that are self-contained and seal against each other to block flow.

18. The spring brake actuator (1) of claim 1, wherein the housing base (4) separates a parking brake part from a service brake part.

19. The spring brake actuator (1) of claim 1, wherein the spring brake actuator (1) is a component of a compressed air brake system of a commercial vehicle.

20. A commercial vehicle, the commercial vehicle comprising:
a spring brake actuator (1) according to claim 2.
